(19) United States
(12) Patent Application Publication
(10) Pub. No.: US 2026/0239038 A1
(43) Pub. Date: Aug. 13, 2026

(54) AMBIENT INTERNET OF THINGS DEVICE READ/WRITE METHOD, READER/WRITER, AND NETWORK SIDE DEVICE

(71) Applicant: VIVO MOBILE COMMUNICATION CO., LTD., Dongguan (CN)

(72) Inventor: Jinhua LIU, Dongguan (CN)

(73) Assignee: VIVO MOBILE COMMUNICATION CO., LTD., Dongguan (CN)

(21) Appl. No.: 19/632,588

(22) Filed: Mar. 30, 2026

Related U.S. Application Data
(63) Continuation of application No. PCT/CN2024/120467, filed on Sep. 23, 2024.

(30) Foreign Application Priority Data
Sep. 28, 2023 (CN) 202311281455.0

(51) Int. Cl. H04W 24/02; H04W 8/22; H04W 12/03; H04W 72/231

(52) U.S. Cl. CPC H04W 24/02; H04W 8/22; H04W 12/03; H04W 72/231

(57) ABSTRACT

An ambient Internet of Things device read/write method includes obtaining, by a reader/writer, operation configuration information from a core network device. The operation configuration information is used to indicate to execute a target operation on a target ambient Internet of Things device. The target operation includes one of a read operation or a write operation. The method further includes executing, by the reader/writer, the target operation on the target ambient Internet of Things device based on the operation configuration information.

### CROSS-REFERENCE TO RELATED APPLICATIONS

This application is a bypass continuation of International Application No. PCT/CN2024/120467, filed September 23, 2024, which claims priority to Chinese Patent Application No. 202311281455.0, filed September 28, 2023. The entire contents of each of the above-referenced applications are expressly incorporated herein by reference.

### TECHNICAL FIELD

This application pertains to the field of wireless communication technologies, and specifically relates to an ambient internet of things device read/write method, a reader/writer, and a network side device.

### BACKGROUND

An Ambient Internet of Things (A-IoT) device features extremely low complexity and extremely low power consumption.

As a type of terminal device, in a case that the A-IoT device needs to perform data transmission with a network side device, before performing data transmission, the A-IoT device needs to send assistance information for assisting data transmission to the network side device. However, an actual service data block of the A-IoT device is small. Air interface resources occupied by the assistance information are more than air interface resources occupied by transmission of service data. Therefore, how to reduce the air interface resources occupied by the assistance information of the A-IoT device in data transmission is a technical problem that needs to be addressed in related technologies.

### SUMMARY

Embodiments of this application provide an ambient Internet of Things device read/write method, a reader/writer, and a network side device.

According to a first aspect, an ambient Internet of Things device read/write method is provided, and includes: A reader/writer obtains operation configuration information from a core network device, where the operation configuration information is used to indicate to execute a target operation on a target ambient Internet of Things device, and the target operation includes one of the following: a read operation and a write operation. The reader/writer executes the target operation on the target ambient Internet of Things device based on the operation configuration information.

According to a second aspect, an ambient Internet of Things device operation configuration method is provided, and includes: A core network device receives an operation request from an application server, where the operation request is used to request to execute a target operation on a target ambient Internet of Things device, and the target operation includes one of the following: a read operation and a write operation. The core network device sends operation configuration information to a reader/writer based on the operation request, where the operation configuration information is used to indicate to execute the target operation on the target ambient Internet of Things device.

According to a third aspect, an ambient Internet of Things device read/write response method is provided, and includes: A target ambient Internet of Things device executes a target operation in response to a reader/writer executing the target operation on the target ambient Internet of Things device based on operation configuration information, where the operation configuration information is used to indicate to execute the target operation on the target ambient Internet of Things device, and the target operation includes one of the following: a read operation and a write operation.

According to a fourth aspect, an ambient Internet of Things device read/write apparatus is provided, and includes: an obtaining module, configured to obtain operation configuration information from a core network device, where the operation configuration information is used to indicate to execute a target operation on a target ambient Internet of Things device, and the target operation includes one of the following: a read operation and a write operation; and a first execution module, configured to execute the target operation on the target ambient Internet of Things device based on the operation configuration information.

According to a fifth aspect, an ambient Internet of Things device operation configuration apparatus is provided, and includes: a receiving module, configured to receive an operation request from an application server, where the operation request is used to request to execute a target operation on a target ambient Internet of Things device, and the target operation includes one of the following: a read operation and a write operation; and a sending module, configured to send operation configuration information to a reader/writer based on the operation request, where the operation configuration information is used to indicate to execute the target operation on the target ambient Internet of Things device.

According to a sixth aspect, an ambient Internet of Things device read/write response apparatus is provided, and includes: a response module, configured to trigger a second execution module in response to a reader/writer executing a target operation on a target ambient Internet of Things device based on operation configuration information, where the operation configuration information is used to indicate to execute the target operation on the target ambient Internet of Things device, and the target operation includes one of the following: a read operation and a write operation; and the second execution module, configured to execute the target operation.

According to a seventh aspect, a reader/writer is provided. The reader/writer includes a processor and a memory, the memory stores a program or an instruction that is executable on the processor, and when the program or the instruction is executed by the processor, the steps of the method according to the first aspect are implemented.

According to an eighth aspect, a reader/writer is provided, including a processor and a communication interface, where the processor is configured to implement the steps of the method according to the first aspect, and the communication interface is configured to communicate with an external device.

According to a ninth aspect, a network side device is provided. The network side device includes a processor and a memory, the memory stores a program or an instruction that is executable on the processor, and the program or the instruction is executed by the processor to implement the steps of the method according to the second aspect.

According to a tenth aspect, a network side device is provided, including a processor and a communication interface. The processor is configured to implement the steps of the method according to the second aspect, and the communication interface is configured to communicate with an external device.

According to an eleventh aspect, an ambient Internet of Things device is provided. The ambient Internet of Things device includes a processor and a memory, the memory stores a program or an instruction that is executable on the processor, and the program or the instruction is executed by the processor to implement the steps of the method according to the third aspect.

According to a twelfth aspect, an ambient Internet of Things device is provided, including a processor and a communication interface. The processor is configured to implement the steps of the method according to the third aspect, and the communication interface is configured to communicate with an external device.

According to a thirteenth aspect, a readable storage medium is provided. A program or an instruction is stored on the readable storage medium, and the program or the instruction is executed by a processor to implement the steps of the method according to the first aspect, the steps of the method according to the second aspect, or the steps of the method according to the third aspect.

According to a fourteenth aspect, a wireless communication system is provided, including: an ambient Internet of Things device, a reader/writer, and a network side device. The ambient Internet of Things device may be configured to perform the steps of the method according to the third aspect, the reader/writer may be configured to perform the steps of the method according to the first aspect, and the network side device may be configured to perform the steps of the method according to the second aspect.

According to a fifteenth aspect, a chip is provided. The chip includes a processor and a communication interface. The communication interface is coupled to the processor. The processor is configured to run a program or an instruction, to implement the method according to the first aspect, the method according to the second aspect, or the method according to the third aspect.

According to a sixteenth aspect, a computer program/program product is provided. The computer program/program product is stored in a storage medium, and the program/program product is executed by at least one processor to implement the method according to the first aspect, the method according to the second aspect, or the method according to the third aspect.

In the embodiments of this application, the reader/writer obtains the operation configuration information from the core network device, and executes the read operation or the write operation on the target ambient Internet of Things device based on the operation configuration information, to achieve data transmission with the ambient Internet of Things device. The ambient Internet of Things device does not need to report assistance information for data transmission, to save air interface resources. Moreover, because the ambient Internet of Things device does not need to exchange signaling with the network side device, complexity of a higher layer protocol stack of the ambient Internet of Things device can also be reduced.

### BRIEF DESCRIPTION OF DRAWINGS

FIG. 1 is a block diagram of a wireless communication system to which embodiments of this application may be applied;

FIG. 2 is a schematic flowchart of an ambient Internet of Things device read/write method according to an embodiment of this application;

FIG. 3a is a schematic diagram of deployment of a reader/writer according to an embodiment of this application;

FIG. 3b is another schematic diagram of deployment of a reader/writer according to an embodiment of this application;

FIG. 3c is still another schematic diagram of deployment of a reader/writer according to an embodiment of this application;

FIG. 4 is a schematic flowchart of an ambient Internet of Things device operation configuration method according to an embodiment of this application;

FIG. 5 is a schematic flowchart of an ambient Internet of Things device read/write response method according to an embodiment of this application;

FIG. 6 is a schematic flowchart of an ambient Internet of Things device read/write method according to an embodiment of this application;

FIG. 7 is another schematic flowchart of an ambient Internet of Things device read/write method according to an embodiment of this application;

FIG. 8 is a schematic diagram of a structure of an ambient Internet of Things device read/write apparatus according to an embodiment of this application;

FIG. 9 is a schematic diagram of a structure of an ambient Internet of Things device operation configuration apparatus according to an embodiment of this application;

FIG. 10 is a schematic diagram of a structure of an ambient Internet of Things device read/write response apparatus according to an embodiment of this application;

FIG. 11 is a schematic diagram of a structure of a communication device according to an embodiment of this application;

FIG. 12 is a schematic diagram of a hardware structure of a terminal according to an embodiment of this application;

FIG. 13 is a schematic diagram of a hardware structure of a network side device according to an embodiment of this application; and

FIG. 14 is a schematic diagram of a hardware structure of another network side device according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as "first" and "second" in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by "first" and "second" are usually of a same type, and a quantity of objects is not limited. For example, there may be one or more first objects. In addition, "or" in this application means at least one of the connected objects. For example, "A or B" includes three solutions, namely: solution 1: include A but exclude B; solution 2: include B but exclude A; and solution 3: include both A and B. The character "/" usually indicates an "or" relationship between the associated objects.

The term "indication" in this application may be a direct indication (or explicit indication) or an indirect indication (or implicit indication). The direct indication may be understood as that a sender explicitly notifies a sent indication of content such as specific information, an operation that needs to be executed, or a request result to a receiver. The indirect indication may be understood as that the receiver determines corresponding information according to the indication sent by the sender, or executes determining according to the indication sent by the sender, and determines, according to a determining result, the operation that needs to be executed, the request result, or the like.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms "system" and "network" in the embodiments of this application may be used interchangeably. The technologies described can be applied to both the systems and the radio technologies mentioned above as well as to other systems and radio technologies. A New Radio (NR) system is described in the following descriptions for illustrative purposes, and the NR terminology is used in most of the following descriptions, although these technologies can also be applied to a system other than the NR system, such as a 6^{th} Generation (6G) communication system.

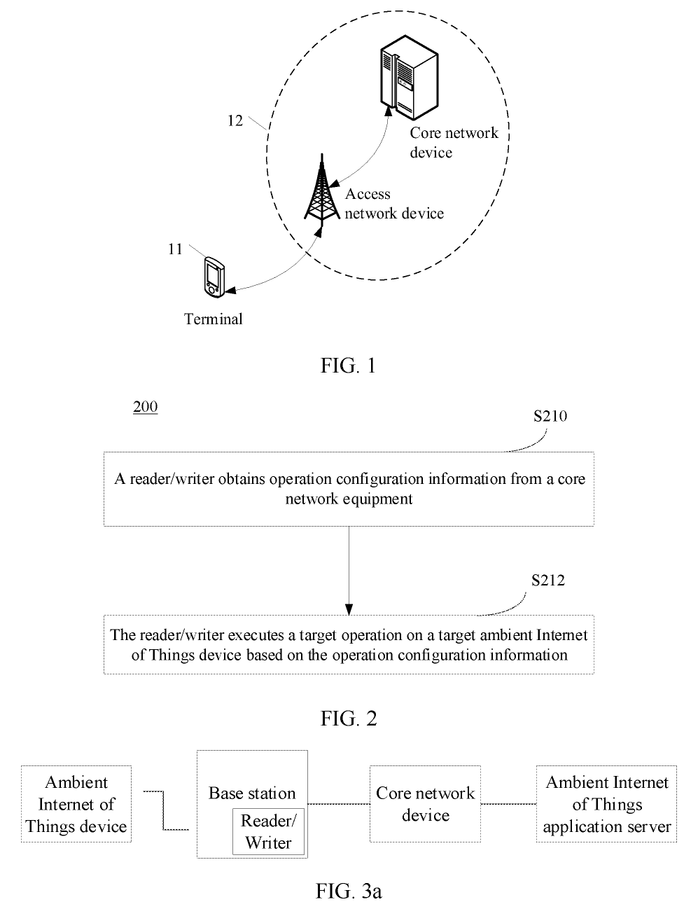

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), ship user equipment, Pedestrian User Equipment (PUE), a smart home (a home device with a wireless communication function, such as a refrigerator, a television, a washing machine, or a furniture), a game console, a personal computer (Personal Computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. The vehicle user equipment may also be referred to as a vehicle terminal, a vehicle controller, a vehicle module, a vehicle component, a vehicle chip, a vehicle unit, or the like. It should be noted that a specific type of the terminal 11 is not limited in the embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), Wireless Fidelity (Wi-Fi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a basic service set (Basic Service Set, BSS), an Extended Service Set (ESS), a home NodeB (HNB), a home evolved NodeB, a Transmission Reception Point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

The core network device may include but is not limited to at least one of the following: a core network node, a core network device function, a Mobility Management Entity, (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function, NRF), a Network Exposure Function (NEF), a Local NEF or L-NEF, a Binding Support Function (BSF), an Application Function (AF), and the like. It should be noted that, in the embodiments of this application, only a core network device in an NR system is used as an example for description, and a specific type of the core network device is not limited.

The Ambient Internet of Things (A-IoT), also referred to as the Ambient power-enabled Internet of Things (Ambient power-enabled IoT), is a type of Internet of Things (IoT) service, where an IoT device is powered by energy harvesting. The IoT device has no battery or has a limited energy storage capability (such as using a capacitor). Energy sources for energy harvesting include radio waves, light, motion, heat, or other suitable energy sources.

Energy of an ambient IoT device comes from energy harvesting. For energy storage, the ambient IoT device may have the following characteristics:

no battery, and no energy storage, that is, the ambient IoT device relies entirely on ab external energy source; or

limited energy storage capability, and no need for battery replacement or charging.

Typically, the ambient IoT device does not have a conventional battery. The ambient IoT device uses energy harvested from radio waves, which the radio waves may come from a network device or user equipment, such as mobile phone UE.

The ambient IoT device may be classified based on the energy source, the energy storage capability, passive or active transmission, and the like.

There are the plurality of communication modes for passive or active transmission of the ambient IoT device:

Normal operation: The ambient IoT device has electrical energy to work continuously or for a period of time. The energy may come from continuous energy harvesting, or may have a specific energy storage capability, for example, equipped with a capacitor.

Active transmission: supports a device-triggered operation. The device can only support an active state in a short period of time, and support intermittent communication. The ambient IoT device may decide when to communicate with a network. The ambient IoT device may not monitor the network, that is, may not monitor a called service for a long time.

Passive transmission: supports only a network-initiated on-demand operation: The ambient IoT device cannot initiate a service.

Backscatter communication means that a backscatter communication device executes signal modulation by using a radio frequency signal in another device or an environment to transmit information. A backscatter communication terminal device (BSC Tags, also referred to as BSC UE) may be a tag in conventional RFID, an ambient-powered IoT (Ambient IoT) device, or a passive IoT (Passive-IoT) device.

The backscatter technology, as a passive or low-energy technology, is characterized by changing a characteristic such as phase or amplitude information of a received ambient radio frequency signal to complete transmission of its own signal, achieving extremely low or zero power consumption for information transmission.

From the perspective of an energy supply manner, backscatter communication terminal devices may be classified into three types: passive, semi-passive, and active.

For passive backscatter communication, the BSC TAG first performs energy harvesting (Energy harvesting) in external electromagnetic waves, and supplies the energy to channel coding and modulation and other internal circuit modules for working, and at the same time, backscatters a radio frequency signal for communication, so as to implement zero-power communication.

For a semi-passive BSC TAG, an internal circuit module of the BSC terminal is powered by its own battery and a radio frequency signal is backscattered for communication. Because its internal battery is only used for work of simple internal circuit modules such as channel coding and modulation, power consumption is quite low. Therefore, the battery life of the BSC TAG can reach more than ten years. All external radio frequency signals may be used for backscatter communication and there is no need to store some energy for power supply.

For an active BSC TAG, a built-in battery of the active BSC terminal can be used not only for work of simple internal circuits such as channel coding and modulation, but also for work of circuits such as a power amplifier (PA) and a low noise amplifier (LNA), so that signal modulation and demodulation with higher complexity for backscatter communication can be implemented.

As a type of terminal device, in a case that the A-IoT device needs to perform data transmission with a network side device, before performing data transmission, the A-IoT device needs to report assistance information for assisting data transmission to the network side device. In some embodiments, the A-IoT device reports the assistance information to a reader/writer. The reader/writer then sends the assistance information to a core network device. However, an actual service data block of the A-IoT device is small. As a result, air interface resources occupied by the assistance information are more than air interface resources occupied by transmission of service data. Moreover, transmitting the assistance information also increases complexity of a higher-layer protocol stack of the A-IoT device. For this problem, embodiments of this application provide an ambient Internet of Things device read/write solution. In the read/write solution provided in the embodiments of this application, a reader/writer obtains operation configuration information from a core network device, and executes a read operation or a write operation on a target ambient Internet of Things device based on the operation configuration information, to achieve data transmission with the ambient Internet of Things device. The ambient Internet of Things device does not need to report assistance information for data transmission, to save air interface resources occupied by the A-IoT device reporting the assistance information to the reader/writer and reduce complexity of a higher-layer protocol stack of the A-IoT device.

The ambient Internet of Things device read/write solution provided in the embodiments of this application is described in detail below with reference to the accompanying drawings by using some embodiments and application scenarios thereof.

FIG. 2 is a schematic flowchart of an ambient Internet of Things device read/write method according to an embodiment of this application. The method 200 may be performed by a reader/writer. In other words, the method may be performed by software or hardware installed in the reader/writer.

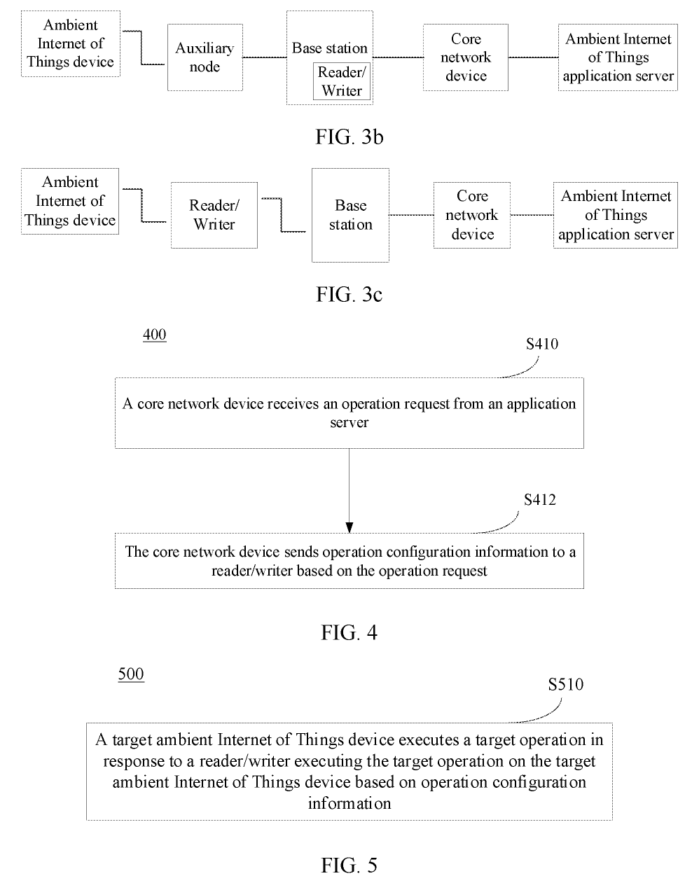

In this embodiment of this application, as shown in FIG. 3a, the reader/writer may be deployed in a base station as a functional module of the base station, and the base station may directly communicate with an A-IoT device. In some embodiments, as shown in FIG. 3b, a reader/writer may be integrated in a base station as a functional unit, and the base station communicates with an A-IoT device via an auxiliary node such as a Network Controlled Repeater (NCR) node or a Reconfigurable Intelligent Surface (RIS) node. In some embodiments, as shown in FIG. 3c, a reader/writer is deployed as a unit separate from a base station. An involved ambient IoT device may be a terminal device based on passive communication or a fixedly deployed read/write device controlled by the base station. The read/write device communicates with the A-IoT device under control of the base station. Communication between the reader/writer and the ambient IoT device may be based on a backscatter communication mechanism or an active communication mode in which the ambient IoT device generates transmission waves.

As shown in FIG. 2, the ambient Internet of Things device read/write method mainly includes the following steps.

S210: The reader/writer obtains operation configuration information from a core network device.

In this embodiment of this application, the operation configuration information is used to indicate to execute a target operation on a target ambient Internet of Things device, and the target operation includes one of the following: a read operation and a write operation.

In this embodiment of this application, the reader/writer obtains the operation configuration information from the core network device. For example, in FIG. 3a and FIG. 3b, the reader/writer may directly receive the operation configuration information sent by the core network device. In FIG. 3c, the reader/writer may obtain the operation configuration information from the core network device via a base station. For example, the core network device may send the operation configuration information to the reader/writer via the base station.

In this embodiment of this application, the core network device may send the operation configuration information to the reader/writer based on a request from an ambient Internet of Things application server. For example, in a case that the ambient Internet of Things application server needs to obtain target information on an ambient Internet of Things device, the ambient Internet of Things application server may send a read request and operation assistance information to the core network device. The operation assistance information may include at least one of identification information of the ambient Internet of Things device, identification information of target information to be obtained, a storage address of the target information, and the like. Upon receiving the read request and the operation assistance information, the core network device generates the operation configuration information based on the read request and the operation assistance information, and sends the operation configuration information to the reader/writer.

In some embodiments, the operation configuration information may include at least one of the following:
(1) first identification information, where the first identification information is used to identify one of the following: the target ambient Internet of Things device and a target ambient Internet of Things device set, and the target ambient Internet of Things device set includes at least one target ambient Internet of Things device; for example, the first identification information may include an identifier of at least one ambient Internet of Things device, used to indicate the ambient Internet of Things device corresponding to the target operation; or the first identification information may include an identifier of at least one ambient Internet of Things device set, used to indicate that the ambient Internet of Things device corresponding to the target operation is each ambient Internet of Things device in the at least one ambient Internet of Things device set;
(2) second identification information, where the second identification information is used to identify target information to be operated by the target operation; for example, the second identification information may be a service identifier corresponding to target information to be read/written; for another example, the second identification information may be a storage name of target information in the target ambient Internet of Things device;
(3) address information, where the address information is used to indicate a storage address of the target information on the target ambient Internet of Things device, where the address information may be used to determine a location at which the target information corresponding to the target operation is stored in the target ambient Internet of Things device;
(4) first indication information, where the first indication information is used to indicate a size of the target information, where the first indication information may indicate a size of the target information to be read or written; and
(5) second indication information, where the second indication information is used to indicate one of the following: to encrypt data transmitted between the target ambient Internet of Things device and the reader/writer and not to encrypt data transmitted between the target ambient Internet of Things device and the reader/writer. Through the second indication information, it can be learned whether encryption is required for data transmitted between the reader/writer and the target ambient Internet of Things device, that is, whether encrypted transmission is performed between the reader/writer and the target ambient Internet of Things device. The reader/writer may perform a corresponding operation based on the second indication information. For example, in a case that the second indication information indicates that encrypted transmission is required, the reader/writer performs data transmission after completing air interface encryption parameter exchange with the target A-IoT device. In a case that the second indication information indicates that encrypted transmission is not required, the reader/writer may perform data transmission without a need of completing air interface encryption parameter exchange with the target A-IoT device. Additionally, in a case that an application layer of the target A-IoT device has encrypted the data, an air interface does not need to encrypt the read data.

S212: The reader/writer executes the target operation on the target ambient Internet of Things device based on the operation configuration information.

The reader/writer executes the corresponding operation on the target ambient Internet of Things device based on the operation configuration information. For example, in a case that the operation configuration information is used to perform a read operation on the target ambient Internet of Things device, the reader/writer executes a read operation of reading target information stored in the target ambient Internet of Things device. In a case that the operation configuration information is used to perform a write operation on the target ambient Internet of Things device, the reader/writer executes a write operation of writing target information into the target ambient Internet of Things device.

According to the technical solution provided in this embodiment of this application, the reader/writer executes the target operation on the target ambient Internet of Things device based on the operation configuration information from the core network, without requiring the A-IoT device to report assistance information for uplink data reading, such as an SR/BSR. This can remove the application layer on the A-IoT device or greatly simplify the application layer on the A-IoT device. The reader/writer may directly read/write a specific memory area on the A-IoT device, to save air interface resources and reduce complexity of a higher-layer protocol stack of the A-IoT device.

In some embodiments, before S212, the method may further include the following steps:

Step 1: The reader/writer reads third identification information of a candidate ambient Internet of Things device from the candidate ambient Internet of Things device.

In this implementation, after obtaining the operation configuration information, the reader/writer may read third identification information of each candidate ambient Internet of Things device within a communication range of the reader/writer to determine the target ambient Internet of Things device. For example, in FIG. 3a, the reader/writer may read the third identification information of the ambient Internet of Things device within coverage of the base station. In FIG. 3b, the reader/writer may obtain the third identification information of the candidate ambient Internet of Things device via an auxiliary node within coverage of the base station. In FIG. 3c, the reader/writer may obtain the third identification information of the candidate ambient Internet of Things device within the communication range of the reader/writer.

Step 2: In a case that the read third identification information matches the first identification information, determining, by the reader/writer, the candidate ambient Internet of Things device as the target ambient Internet of Things device.

After obtaining the third identification information of the candidate ambient Internet of Things device, the reader/writer may determine whether the third identification information matches the first identification information. For example, in a case that the first identification information includes identification information of at least one target ambient Internet of Things device, it is determined whether the third identification information is one of at least one piece of identification information included in the first identification information. In a case that the first identification information includes identification information of at least one target ambient Internet of Things device set, it is determined whether the third identification information is identification information of a target ambient Internet of Things device in the target ambient Internet of Things device set indicated by the first identification information. A candidate ambient Internet of Things device whose third identification information matches the first identification information is used as the target ambient Internet of Things device.

In some embodiments, the operation configuration information may be read configuration information, used to indicate to perform a read operation on the target ambient Internet of Things device. Then, in S212, the reader/writer may execute, based on the operation configuration information, a read operation of reading target information from the target ambient Internet of Things device. For example, the reader/writer may read the target information from the target ambient Internet of Things device based on the read configuration information from the core network, without requiring the target ambient Internet of Things device to report assistance information for uplink data reading beforehand. This can remove or simplify an application layer on the target ambient Internet of Things device, save air interface resources, and reduce complexity of the target ambient Internet of Things device.

In some embodiments, the operation configuration information may further include at least one of (1) to (4) below.

(1) Third indication information, where the third indication information is used to indicate to execute one read operation on the target ambient Internet of Things device. Therefore, the third indication information may also be referred to as a single-read indication, indicating the reader/writer to read the target information from the target ambient Internet of Things device once.

(2) Fourth indication information, where the fourth indication information is used to indicate to execute a periodic read operation on the target ambient Internet of Things device. Therefore, the fourth indication information may also be referred to as periodic read configuration information.

In some embodiments, the fourth indication information may include: time-related information of first-time read and read periodicity information, and the time-related information of the first-time read includes one of the following: time offset information of the first-time read and read time of the first-time read. The reader/writer may determine, based on the time-related information of the first-time read in the fourth indication information, time for reading the target information from the target ambient Internet of Things device for the first time, then read the target information at the time for the first time, afterwards, when a read periodicity indicated by the read periodicity information arrives, performs second-time read, and periodically read the target information from the target ambient Internet of Things device.

In some embodiments, the time offset information of the first-time read may be an offset of the time of the first-time read relative to time of receiving the operation configuration information. For example, the time offset information of the first-time read may indicate n slots, and then the reader/writer performs the first-time read at an n^{th} slot after receiving the operation configuration information.

(3) Fifth indication information, where the fifth indication information is used to indicate to execute a semi-static read operation on the target ambient Internet of Things device.

In some embodiments, the fifth indication information may include: time-related information of first-time read and read periodicity information, and the time-related information of the first-time read includes one of the following: time offset information of the first-time read and read time of the first-time read. The reader/writer may determine, based on the time-related information of the first-time read in the fourth indication information, time for reading the target information from the target ambient Internet of Things device for the first time, then read the target information at the time for the first time, and afterwards, when a read periodicity indicated by the read periodicity information arrives, performs second-time read.

In some embodiments, when the operation configuration information includes the fifth indication information indicating to execute the semi-static read operation, the reader/writer may determine a total quantity of read times according to a protocol agreement or a default configuration, or determine a time period for executing the semi-static read operation according to the protocol agreement or the default configuration, or stop periodically reading the target information when receiving, next time, the operation configuration information indicating the read operation.

In some embodiments, the fifth indication information may further include at least one of the following:

a) An indication to activate or reactivate the semi-static read operation. Through the indication, the reader/writer may determine to activate or reactivate the semi-static read operation and read the target information from the target ambient Internet of Things device in a semi-static read manner.

b) An indication to stop or pause the semi-static read operation. Through the indication, the reader/writer may be indicated to stop or pause the currently executed semi-static read operation. For example, in a case that the reader/writer is currently executing the semi-static read operation for information stored in the target ambient Internet of Things device, the fifth indication information may indicate to stop or pause the semi-static read operation.

c) An indication of a time period for executing the semi-static read operation. Through the indication, the time period during which the reader/writer executes the semi-static read operation on the target information may be indicated. That is, the target information is periodically read within the time period, and reading of the target information is stopped when the time period expires.

d) A quantity of read times for executing the semi-static read operation. Through the indication, a quantity of times that the reader/writer executes the semi-static read operation on the target information, that is, a quantity of times of reading the target information according to the read periodicity indicated by the read periodicity information, may be indicated, and reading of the target information is stopped after the quantity of times is exceeded.

(4) Transmission/reception capability information of the target ambient Internet of Things device. The transmission/reception capability information of the target ambient Internet of Things device is indicated, so that the reader/writer may perform data reading according to a transmission/reception capability of the target ambient Internet of Things device, to avoid data read interruption. For example, for an A-IoT device powered based on energy harvesting, the transmission/reception capability information may include an energy harvesting duration parameter, continuous transmission/reception duration after full charge, a maximum uplink transmit power, and the like. The reader/writer may perform data reading in a manner matching the transmission/reception capability of the target A-IoT device, to avoid data read interruption.

In some embodiments, that the reader/writer executes the read operation of reading the target information from the target ambient Internet of Things device may include the following steps:

Step 1: The reader/writer sends first downlink control information to the target ambient Internet of Things device, where the first downlink control information includes at least one of the following: a read operation indication, the second identification information, the address information, and the first indication information.

Step 2: The reader/writer receives a read result returned by the target ambient Internet of Things device.

This implementation provides one way for the reader/writer to execute a read operation, but is not limited to this. In practical applications, the reader/writer may read target information from the target ambient Internet of Things device in other ways. For example, the reader/writer may send a query instruction for querying the target information to the target ambient Internet of Things device. Upon receiving the query instruction, the target ambient Internet of Things device responds by querying locally stored target information and returning it to the reader/writer.

In some embodiments, the target A-IoT device directly sends the data specified by the reader/writer to the reader/writer, eliminating the need for processes to obtain sending data from the application layer, thus reducing the complexity of the target A-IoT device.

To avoid read failures or meaningless reads, in some embodiments, before the reader/writer sends the first downlink control information to the target ambient Internet of Things device, the method may further include:

Step 1: The reader/writer sends an inquiry request to the target ambient Internet of Things device, where the inquiry request is used to inquire at least one of the following: whether the target information is stored and whether the target information changes relative to content that is read most recently.

Step 2: The reader/writer receives feedback information returned by the target ambient Internet of Things device.

In some embodiments, the reader/writer may know, before sending the first downlink control information, whether the target information is stored in the target ambient Internet of Things device or whether the target information changes relative to content that is read most recently, and therefore determine, based on the feedback information returned by the target ambient Internet of Things device, whether to send the first downlink control information, to avoid a read failure or invalid read.

In some embodiments, that the reader/writer sends the first downlink control information to the target ambient Internet of Things device may include: The reader/writer sends the first downlink control information to the target ambient Internet of Things device in a case that the feedback information indicates that the target information is stored and the target information changes relative to the content that is read most recently. This implementation can avoid the read failure because the target information is not stored in the target ambient Internet of Things device or the invalid read because the target information stored in the target ambient Internet of Things device does not change relative to the most recent read.

In the foregoing implementation, the reader/writer terminates a read procedure of the target information in a case that the feedback information indicates that the target information is not stored or the target information does not change relative to the content that is read most recently.

In some embodiments, after the reader/writer executes, based on the operation configuration information, a read operation of reading the target information from the target ambient Internet of Things device, the method further includes: The reader/writer sends a read result of executing the read operation to the core network device. The read result may include one of the following: the target information is read, the read operation is not successfully executed, or the read operation is not executed. For example, in a case that the reader/writer reads the target information, the reader/writer sends the read target information to the core network device. In a case that the reader/writer does not successfully execute the read operation, for example, the target information is not stored in the target ambient Internet of Things device, the reader/writer sends a message indicating that the read operation is not successfully executed to the core network device. In a case that the reader/writer does not execute the read operation, for example, the target information stored in the target ambient Internet of Things device does not change relative to the most recent read, the reader/writer sends a message indicating that the read operation is not executed to the core network device.

In some embodiments, in a case that the read result is that the read operation is not successfully executed or the read operation is not executed, the reader/writer may further send read execution information to the core network device, where the read execution information is used to indicate a cause of not successfully executing the read operation or not executing the read operation.

In some embodiments, the cause of not successfully executing the read operation or not executing the read operation includes one of the following:

(1) The target ambient Internet of Things device is not found. For example, identification information of all read candidate ambient Internet of Things devices does not match the first identification information.

(2) The target ambient Internet of Things device is found, but reading the target information fails. For example, the target information is not stored in the target ambient Internet of Things device.

(3) The target ambient Internet of Things device is found, but the target information does not change after being read most recently.

In the foregoing implementation, the core network device can know a cause of failure to read the target information when the target information is not read.

In some embodiments, the operation configuration information may be read configuration information, used to indicate to perform a read operation on the target ambient Internet of Things device. Then, in S212, the reader/writer may execute, based on the operation configuration information, a write operation of writing the target information into the target ambient Internet of Things device.

In the foregoing implementation, the reader/writer directly writes the target information into the target A-IoT device. The target A-IoT device places, in a specified memory area, received data stored in a specified memory area. There is no need to submit the received data to the application layer, reducing complexity of the target A-IoT device.

In the foregoing implementation, the operation configuration information may further include: downlink reception capability information of the target ambient Internet of Things device. For example, the downlink reception capability information of the target ambient Internet of Things device may include duration for which the target ambient Internet of Things device performs continuous receiving, and a time parameter for the target ambient Internet of Things device to harvest energy. This enables the reader/writer to write the target information into the target ambient Internet of Things device according to the downlink reception capability information of the target ambient Internet of Things device, to avoid a write failure.

In some embodiments, that the reader/writer executes, based on the operation configuration information, the write operation of writing the target information into the target ambient Internet of Things device may include the following steps:

Step 1: The reader/writer sends second downlink control information to the target ambient Internet of Things device, where the second downlink control information includes at least one of the following: a write operation indication, second identification information for identifying the target information on which the target A-IoT device performs the write operation, storage address information of the target information on the target A-IoT device, and the first indication information. The second identification information may be used by the target A-IoT device to determine a storage file, storage space, and the like for the target information.

After receiving the second downlink control information, the target A-IoT device receives and stores the target information from the reader/writer according to the second downlink control information.

Step 2: The reader/writer obtains an operation result of executing the write operation by the target ambient Internet of Things device.

For example, the target ambient Internet of Things device may return a response indicating successful completion of the write operation to the reader/writer after successfully storing the target information locally. Then, the operation result obtained by the reader/writer is successful completion of the write operation. In a case that identification information of all read candidate ambient Internet of Things devices does not match the first identification information, the operation result obtained by the reader/writer may be that the write operation is not executed. In a case that the target ambient Internet of Things device fails to store the target information locally, such as insufficient storage space, the target ambient Internet of Things device may return a response indicating a failure of the write operation to the reader/writer. Then, the operation result obtained by the reader/writer is that the write operation is not successfully executed.

In some embodiments, after the reader/writer obtains the operation result of the target ambient Internet of Things device executing the write operation, the method may further include: The reader/writer sending write operation execution information to the core network device, where the write operation execution information includes one of the following: successful completion of the write operation and a cause of not successfully executing the write operation or not executing the write operation.

In some embodiments, the cause of not successfully executing the write operation or not executing the write operation may include one of the following: the target ambient Internet of Things device is not found; and the target ambient Internet of Things device is found, but the write operation fails.

In the foregoing implementation, the reader/writer may send the write operation execution information to the core network device, so that the core network device can know the write operation execution information.

FIG. 4 is a schematic flowchart of an ambient Internet of Things device operation configuration method according to an embodiment of this application. The method 400 may be performed by a core network device. In other words, the method may be performed by software or hardware installed on the core network device. As shown in FIG. 4, the method mainly includes the following steps.

S410: The core network device receives an operation request from an application server.

In this embodiment of this application, the operation request is used to request to execute a target operation on a target ambient Internet of Things device, and the target operation includes one of the following: a read operation and a write operation.

In this embodiment of this application, the application server may be an ambient Internet of Things application server. The application server may send the operation request to the core network device when needing to perform the target operation with the target ambient Internet of Things device.

In some embodiments, the operation request may carry operation assistance information, or the operation assistance information may be sent together with the operation request to the core network device. The operation assistance information may include at least one of the following: identification information of the target ambient Internet of Things device corresponding to the target operation, identification information of target information to be operated by the target operation, a size of the target information, an operation indication, and the like.

S412: The core network device sends operation configuration information to a reader/writer based on the operation request.

In this embodiment of this application, the operation configuration information is used to indicate to execute the target operation on the target ambient Internet of Things device. The operation configuration information is the same as the operation configuration information in the method 200. For details, refer to the related descriptions in the method 200.

In this embodiment of this application, the core network device obtains corresponding, reader/writer-recognizable operation configuration information based on the operation request sent by the application server, and sends the operation configuration information to the reader/writer. In a case that the reader/writer is deployed at a base station, the core network device may directly send the operation configuration information to the reader/writer. In a case that the reader/writer is deployed separately from the base station, the core network device may send the operation configuration information to the reader/writer via the base station.

With the technical solution provided in this embodiment of this application, when an application server needs to obtain target information stored in a target ambient Internet of Things device or needs to send target information to the target environment IoT device, it can send an operation request to a core network device. The core network device then sends operation configuration information to a reader based on the operation request, thereby enabling the reader to directly read from or write to the target environment IoT device without requiring the involvement of the target environment IoT device.

In some embodiments, the operation configuration information includes at least one of the following:
(1) first identification information, where the first identification information is used to identify one of the following: the target ambient Internet of Things device and a target ambient Internet of Things device set, and the target ambient Internet of Things device set includes at least one target ambient Internet of Things device;
(2) second identification information, where the second identification information is used to identify target information to be operated by the target operation;
(3) address information, where the address information is used to indicate a storage address of the target information on the target ambient Internet of Things device;
(4) first indication information, where the first indication information is used to indicate a size of the target information; and
(5) second indication information, where the second indication information is used to indicate one of the following: to encrypt data transmitted between the target ambient Internet of Things device and the reader/writer and not to encrypt data transmitted between the target ambient Internet of Things device and the reader/writer.

In some embodiments, the operation configuration information may include read configuration information, and the read configuration information is used to indicate to execute a read operation on the target ambient Internet of Things device.

In some embodiments, the operation configuration information may further include at least one of the following:
(1) third indication information, where the third indication information is used to indicate to execute one read operation on the target ambient Internet of Things device; for details, refer to the related descriptions in the method 200;
(2) fourth indication information, where the fourth indication information is used to indicate to execute a periodic read operation on the target ambient Internet of Things device; for details, refer to the related descriptions in the method 200;
(3) fifth indication information, where the fifth indication information is used to indicate to execute a semi-static read operation on the target ambient Internet of Things device; for details, refer to the related descriptions in the method 200; and
(4) transmission/reception capability information of the target ambient Internet of Things device; for details, refer to the related descriptions in the method 200.

In some embodiments, after the core network device sends the operation configuration information to the reader/writer based on the operation request, the method further includes: receiving a read result sent by the reader/writer.

In some embodiments, the core network device may obtain the read result of the read operation. In some embodiments, the core network device may send the received read result to the application server.

In some embodiments, after the core network device sends the operation configuration information to the reader/writer based on the operation request, the method further includes: in a case that the read result is that the read operation is not successfully executed or the read operation is not executed, receiving read execution information sent by the reader/writer, where the read execution information is used to indicate a cause of not successfully executing the read operation or not executing the read operation. In some embodiments, the core network device may know the cause of failure to read the target information. In some embodiments, the core network device may send the received read execution information to the application server.

In some embodiments, the cause of not successfully executing the read operation or not executing the read operation includes one of the following:
(1) the target ambient Internet of Things device is not found;
(2) the target ambient Internet of Things device is found, but reading the target information fails; and
(3) the target ambient Internet of Things device is found, but the target information does not change after being read most recently.

In some embodiments, the operation configuration information includes write configuration information, and the write configuration information is used to indicate to execute a write operation on the target ambient Internet of Things device. For example, the application server indicates, by using the operation request, that the target information needs to be written into the target ambient Internet of Things device, and then the operation configuration information sent by the core network device to the reader/writer is the write configuration information.

In some embodiments, the operation configuration information may further include: downlink reception capability information of the target ambient Internet of Things device.

In some embodiments, after the core network device sends the operation configuration information to the reader/writer based on the operation request, the method may further include: receiving write operation execution information sent by the reader/writer, where the write operation execution information includes one of the following: successful completion of the write operation and a cause of not successfully executing the write operation or not executing the write operation.

In some embodiments, the cause of not successfully executing the write operation or not executing the write operation includes one of the following:

the target ambient Internet of Things device is not found; and

the target ambient Internet of Things device is found, but the write operation fails.

According to the technical solution provided in this embodiment of this application, the core network device may send the operation configuration information to the reader/writer based on the operation request sent by the application server, so that the reader/writer can directly read the target information of the A-IoT device or execute the write operation on the target information of the target A-IoT device based on the operation configuration information sent by the core network device. In this way, target information reporting of the A-IoT device is not required (relative to an SR/BSR procedure), signaling overheads are reduced, a requirement for an existing 3GPP PDCP/RLC/MAC packet assembly is eliminated, complexity of a protocol stack of the A-IoT device is reduced, and read and write are directly performed on target space of a plurality of A-IoT devices without executing read and write operations at an application layer of the target A-IoT device, thereby eliminating or simplifying a function of processing service data at the application layer of the A-IoT device.

FIG. 5 is a schematic flowchart of an ambient Internet of Things device read/write response method according to an embodiment of this application. The method 500 may be performed by a target ambient Internet of Things device. In other words, the method may be performed by software or hardware installed on the target ambient Internet of Things device. As shown in FIG. 5, the method mainly includes the following steps.

S510: The target ambient Internet of Things device executes a target operation in response to a reader/writer executing the target operation on the target ambient Internet of Things device based on operation configuration information.

In this embodiment of this application, the operation configuration information is used to indicate to execute the target operation on the target ambient Internet of Things device, and the target operation includes one of the following: a read operation and a write operation. The operation configuration information is the same as the operation configuration information in the foregoing method 200, and the reader/writer may execute the target operation on the target ambient Internet of Things device based on the descriptions in the foregoing method 200. For details, refer to the related descriptions in the foregoing method 200. Details are not described herein again.

In some embodiments, before that the target ambient Internet of Things device executes a target operation in response to a reader/writer executing the target operation on the target ambient Internet of Things device based on operation configuration information, the method may further include: sending identification information of the target ambient Internet of Things device to the reader/writer in response to a request from the reader/writer to read the identification information of the target ambient Internet of Things device. In some embodiments, the reader/writer may determine the target ambient Internet of Things device.

In some embodiments, that the target ambient Internet of Things device executes a target operation in response to a reader/writer executing the target operation on the target ambient Internet of Things device based on operation configuration information may include the following steps:

Step 1: Receive first downlink control information sent by the reader/writer, where the first downlink control information includes at least one of the following: a read operation indication, second identification information identifying target information to be read by the read operation, storage address information of the target information on the target ambient Internet of Things device, and first indication information indicating a size of the target information.

Step 2: Obtain the target information from internal storage space based on the first downlink control information.

Step 3: Return the obtained target information to the reader/writer.

In some embodiments, before the receiving first downlink control information sent by the reader/writer, the method may further include the following steps:

Step 1: Receive an inquiry request sent by the reader/writer, where the inquiry request is used to inquire at least one of the following: whether the target information is stored and whether the target information changes relative to content that is read most recently.

Step 2: Send feedback information to the reader/writer, where the feedback information indicates that the target ambient Internet of Things device stores the target information and the target information changes relative to the content that is read most recently.

In the foregoing implementation, an unnecessary reading process can be avoided, and reading efficiency can be improved.

In some embodiments, that the target ambient Internet of Things device executes a target operation in response to a reader/writer executing the target operation on the target ambient Internet of Things device based on operation configuration information may include the following steps:

Step 1: Receive second downlink control information sent by the reader/writer, where the second downlink control information includes at least one of the following: a write operation indication, second identification information used to indicate target information to be written by the write operation, storage address information of the target information on the target ambient Internet of Things device, and first indication information indicating a size of the target information.

Step 2: Receive the target information from the reader/writer based on the second downlink control information, and store the target information internally.

In the foregoing implementation, after successfully writing the target information, the target ambient Internet of Things device may return a write operation success response to the reader/writer; and after failing to write the target information, for example, storage space is insufficient, the target ambient Internet of Things device returns a write operation failure response to the reader/writer, so that the reader/writer can learn of a write operation result.

According to the technical solution provided in this embodiment of this application, the target A-IoT device may directly respond to the target operation of the reader/writer, and perform the read operation of the target information or the write operation of the target information. In this way, target information reporting of the A-IoT device is not required (relative to an SR/BSR procedure), signaling overheads are reduced, a requirement for an existing 3GPP PDCP/RLC/MAC packet assembly is eliminated, complexity of a protocol stack of the A-IoT device is reduced, and read and write are directly performed on target space of a plurality of A-IoT devices without executing read and write operations at an application layer of the target A-IoT device, thereby eliminating or simplifying a function of processing service data at the application layer of the A-IoT device.

To better understand the technical solutions provided in the embodiments of this application, the following separately describes a procedure of the read operation of the target information and a procedure of the write operation of the target information.

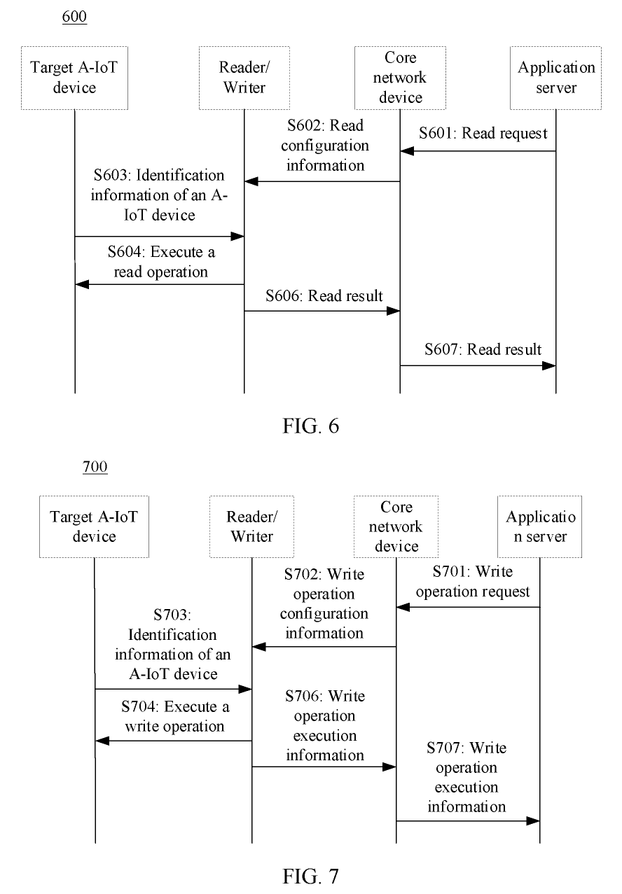

FIG. 6 is a schematic flowchart of an ambient Internet of Things device read/write method according to an embodiment of this application. In the method 600, a reader/writer receives read configuration information of a target A-IoT device or a target A-IoT device set from a core network, performs a read operation on the target A-IoT device or the target A-IoT device set, and sends a read operation result to the core network. As shown in FIG. 6, the method mainly includes the following steps.

S601: An application server sends a read request to a core network device.

The read request may carry read assistance information, or the read assistance information may be sent together with the read request.

The read request may be used to request to read target information in the target A-IoT device or the target A-IoT device set, and the read assistance information may be used to indicate the target A-IoT device or the target A-IoT device set, the target information, and the like.

S602: The core network device sends the read configuration information to the reader/writer based on the read request.

The read configuration information may include one or any combination of the following:
(1) identification information of the target A-IoT device or identification information of the target A-IoT device set;
(2) a target information identifier, which is used by the reader/writer or the target A-IoT device to determine the target information that needs to be read;
(3) storage address information of the target information on the A-IoT device;
(4) a size of the target information;
(5) a read indication at a single time, which indicates the reader/writer to perform reading on the A-IoT device at a single time;
(6) periodic read configuration information, which may include time offset information of first-time read, time of the first-time read, a read periodicity, or the like;
(7) semi-persistent read information, which may include information such as time offset information of first-time read, time of the first-time read, a read periodicity, a quantity of read times, or a time period for performing periodic read;
(8) transmission/reception capability information of the target A-IoT device, which, for the A-IoT device that provides power based on energy collection, includes an energy collection duration parameter, continuous transmission/reception duration after being fully charged, maximum uplink transmit power, or the like, where the transmission/reception capability information may be used to enable the reader/writer to read data based on a transmission/reception capability of the target A-IoT device, to avoid data read interruption; and
(9) implicitly or explicitly indicate whether encrypted transmission needs to be performed on an air interface, where for example, in a case that encrypted transmission needs to be performed, the reader/writer is indicated to perform transmission after completing air interface encryption parameter exchange with the target A-IoT device; and otherwise, can perform transmission without performing air interface encryption parameter exchange with the target A-IoT device; or in a case that an application layer of the target A-IoT device has encrypted the data, an air interface does not need to encrypt the read data.

S603: The reader/writer reads the identification information of the A-IoT device from the A-IoT device; and in a case that the read identification information matches the identification information of the target A-IoT device received from the core network device, the reader/writer determines that the target A-IoT device is found, and S604 is performed.

S604: The reader/writer performs a read operation on the target A-IoT device.

In some embodiments, that the reader/writer performs a read operation on the target A-IoT device may include the following steps:

Step 1: The reader/writer sends downlink control information to the target A-IoT device, where the downlink control information includes at least one of the following: a read operation indication, a target information identifier, a storage address indication of the target information, a length of the target information, and the like.

Step 2: After receiving the downlink control information, the target A-IoT device sends the target information to the reader/writer based on the downlink control information.

Step 3: The reader/writer receives the information sent by the target A-IoT device.

In some embodiments, that the reader/writer performs a read operation on the target A-IoT device may further include the following steps:

Step 1: The reader/writer sends an inquiry request of the target information to the target A-IoT device, where the inquiry request is used to inquire: (1) whether the target information is ready, and (2) whether the target information changes relative to last-time read.

Step 2: The target A-IoT device sends feedback information for (1) or (2) to the reader/writer.

Step 3: The reader/writer receives the feedback information for (1) or (2) from the target A-IoT device; and in a case that the target information is not ready or does not change relative to content read and written last time, the reader/writer may terminate a procedure of reading information from the target A-IoT device; and otherwise, read the target information from the target A-IoT device.

Step 4: In a case that the reader/writer terminates the read procedure of the target information, the reader/writer sends, to the core network, indication information indicating that the target information is not read or that the target information does not change.

In some embodiments, the reader/writer may further send execution information of the read operation to the core network, where the read execution information includes a cause of not successfully executing the read operation or not executing the read operation, and the cause may include one of the following:
(1) the target A-IoT device is not found;
(2) the A-IoT device is found but read fails; and
(3) the A-IoT device is found but the target information has not changed from the last-time read, and read is not required.

S605: The reader/writer sends the read result to the core network.

S606: The core network sends the received read result to the application server.

FIG. 7 is another schematic flowchart of an ambient Internet of Things device read/write method according to an embodiment of this application. In the method 700, a reader/writer receives write operation configuration information of a target A-IoT device or a target A-IoT device set from a core network, performs a write operation on the target A-IoT device or the target A-IoT device set, and sends a write operation result to the core network. As shown in FIG. 7, the method mainly includes the following steps.

S701: An application server sends a write operation request to a core network device.

The write operation request may be used to request to write target information into the target A-IoT device or the target A-IoT device set, and the write operation request may carry write operation assistance information; or the application server may send the write operation request and the write operation assistance information to the core network device together, and the write operation assistance information may be used to indicate the target A-IoT device or the target A-IoT device set, the target information, and the like.

S702: The core network device sends the write operation configuration information to the reader/writer based on the write request.

In some embodiments, the write operation configuration information may include at least one of the following:
(1) identification information of the target A-IoT device or identification information of the target A-IoT device set;
(2) a target information identifier for performing the write operation on the target A-IoT device, which is used by the A-IoT device to determine a storage file, storage space, and the like of the target information;
(3) storage address information of the target information on the A-IoT device;
(4) a size of the target information;
(5) downlink reception capability information, which includes continuous receiving duration and an energy collection time parameter; and
(6) implicitly or explicitly indicate whether encrypted transmission needs to be performed on an air interface, where for example, in a case that encrypted transmission needs to be performed, the reader/writer is indicated to perform transmission after completing air interface encryption parameter exchange with the target A-IoT device; and otherwise, performs transmission without performing air interface encryption parameter exchange with the target A-IoT device; or in a case that an application layer of the target A-IoT device has encrypted the data, an air interface does not need to encrypt the read data.

S703: The reader/writer reads the identification information of the A-IoT device from the A-IoT device; and in a case that the read identification information matches the identification information of the target A-IoT device received from the core network device, the reader/writer determines that the target A-IoT device is found, and S704 is performed.

S704: The reader/writer performs a write operation on the target A-IoT device.

In some embodiments, that the reader/writer performs a write operation on the target A-IoT device may include the following steps:

Step 1: The reader/writer sends downlink control information to the target A-IoT device, where the downlink control information includes a read operation indication, a target information identifier, a storage address indication of the target information, a length of the target information, and the like.

Step 2: After receiving the downlink control information, the target A-IoT device receives the target information from the reader/writer based on the downlink control information and stores the target information.

In some embodiments, the A-IoT device may perform the write operation based on the following steps:

Step 1: The target A-IoT device receives the target information from the reader/writer.

Step 2: The target A-IoT device receives data based on the target information identifier and the storage address information of the target information, and stores the received information in internal storage space.

S705: The reader/writer sends write operation execution information to the core network.

The write operation execution information may include one of the following: successful completion of the write operation and a cause of not successfully executing the write operation or not executing the write operation.

In some embodiments, the cause of not successfully executing the write operation or not executing the write operation may include one of the following:
(1) the target A-IoT device is not found; and
(2) the A-IoT device is found but the write operation fails.

S706: The core network sends the received write operation execution information to the application server.

According to the technical solution provided in this embodiment of this application, the reader/writer is enabled to directly read the target information of the A-IoT device or execute the write operation on a target memory of the target A-IoT device based on the read/write configuration information of the core network. In this way, target information reporting of the A-IoT device is not required (relative to an SR/BSR procedure), signaling overheads are reduced, a requirement for an existing 3GPP PDCP/RLC/MAC packet assembly is eliminated, complexity of a protocol stack is reduced, and read and write are directly performed on target space of a plurality of A-IoT devices without executing read and write operations at an application layer of the target A-IoT device, thereby eliminating or simplifying a function of processing service data at the application layer of the A-IoT device.

The ambient Internet of Things device read/write method provided in the embodiments of this application may be performed by an ambient Internet of Things device read/write apparatus. In the embodiments of this application, an example in which the ambient Internet of Things device read/write apparatus performs the ambient Internet of Things device read/write method is used to describe the ambient Internet of Things device read/write apparatus provided in the embodiments of this application.

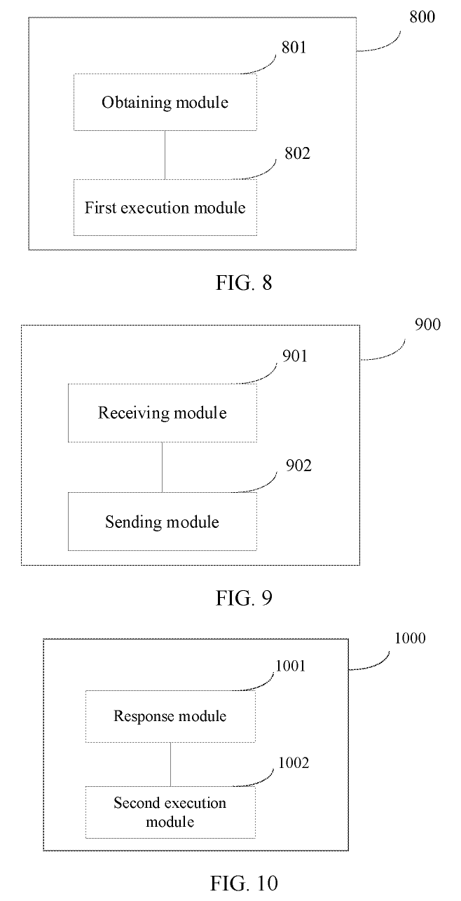

FIG. 8 is a schematic diagram of a structure of an ambient Internet of Things device read/write apparatus according to an embodiment of this application. As shown in FIG. 8, the apparatus 800 mainly includes an obtaining module 801 and a first execution module 802.

In this embodiment of this application, the obtaining module 801 is configured to obtain operation configuration information from a core network device, where the operation configuration information is used to indicate to execute a target operation on a target ambient Internet of Things device, and the target operation includes one of the following: a read operation and a write operation. The first execution module 802 is configured to execute the target operation on the target ambient Internet of Things device based on the operation configuration information.

In some embodiments, the operation configuration information includes at least one of the following:

first identification information, where the first identification information is used to identify one of the following: the target ambient Internet of Things device and a target ambient Internet of Things device set, and the target ambient Internet of Things device set includes at least one target ambient Internet of Things device;

second identification information, where the second identification information is used to identify target information to be operated by the target operation;

address information, where the address information is used to indicate a storage address of the target information on the target ambient Internet of Things device;

first indication information, where the first indication information is used to indicate a size of the target information; and

second indication information, where the second indication information is used to indicate one of the following: to encrypt data transmitted between the target ambient Internet of Things device and the reader/writer and not to encrypt data transmitted between the target ambient Internet of Things device and the reader/writer.

In some embodiments, the obtaining module 801 is configured to:

read third identification information of a candidate ambient Internet of Things device from the candidate ambient Internet of Things device; and

in a case that the read third identification information matches the first identification information, determine the candidate ambient Internet of Things device as the target ambient Internet of Things device.

In some embodiments, the operation configuration information includes read configuration information, and the read configuration information is used to indicate to execute a read operation on the target ambient Internet of Things device; and

the executing the target operation on the target ambient Internet of Things device based on the operation configuration information includes: executing, based on the operation configuration information, a read operation of reading the target information from the target ambient Internet of Things device.

In some embodiments, the operation configuration information further includes at least one of the following:

third indication information, where the third indication information is used to indicate to execute one read operation on the target ambient Internet of Things device;

fourth indication information, where the fourth indication information is used to indicate to execute a periodic read operation on the target ambient Internet of Things device;

fifth indication information, where the fifth indication information is used to indicate to execute a semi-static read operation on the target ambient Internet of Things device; and

transmission/reception capability information of the target ambient Internet of Things device.

In some embodiments , the fourth indication information and the fifth indication information each include: time-related information of first-time read and read periodicity information, and the time-related information of the first-time read includes one of the following: time offset information of the first-time read and read time of the first-time read.

In some embodiments , the fifth indication information further includes at least one of the following:

an indication to activate or reactivate the semi-static read operation;

an indication to stop or pause the semi-static read operation;

an indication of a time period for executing the semi-static read operation; and

a quantity of read times for executing the semi-static read operation.

In some embodiments , the executing, based on the operation configuration information, a read operation of reading the target information from the target ambient Internet of Things device includes:

sending first downlink control information to the target ambient Internet of Things device, where the first downlink control information includes at least one of the following: a read operation indication, the second identification information, the address information, and the first indication information; and

receiving a read result returned by the target ambient Internet of Things device.

In some embodiments, the obtaining module 801 is further configured to:

send an inquiry request to the target ambient Internet of Things device, where the inquiry request is used to inquire at least one of the following: whether the target information is stored and whether the target information changes relative to content that is read most recently; and

receive feedback information returned by the target ambient Internet of Things device.

In some embodiments, the sending first downlink control information to the target ambient Internet of Things device includes:

sending the first downlink control information to the target ambient Internet of Things device in a case that the feedback information indicates that the target information is stored and the target information changes relative to the content that is read most recently.

In an optional implementation, the first execution module 802 is further configured to terminate a read procedure of the target information in a case that the feedback information indicates that the target information is not stored or the target information does not change relative to the content that is read most recently.

In some embodiments, a transmission module is further included, and is configured to send a read result of executing the read operation to the core network device.

In some embodiments, the transmission module is further configured to: in a case that the read result is that the read operation is not successfully executed or the read operation is not executed, send read execution information to the core network device, where the read execution information is used to indicate a cause of not successfully executing the read operation or not executing the read operation.

In some embodiments, the cause of not successfully executing the read operation or not executing the read operation includes one of the following:

the target ambient Internet of Things device is not found;

the target ambient Internet of Things device is found, but reading the target information fails; and

the target ambient Internet of Things device is found, but the target information does not change after being read most recently.

In some embodiments, the operation configuration information includes write configuration information, and the write configuration information is used to indicate to execute a write operation on the target ambient Internet of Things device; and the executing the target operation on the target ambient Internet of Things device based on the operation configuration information includes: executing, based on the operation configuration information, a write operation of writing the target information into the target ambient Internet of Things device.

In some embodiments, the operation configuration information further includes: downlink reception capability information of the target ambient Internet of Things device.

In some embodiments, the executing, based on the operation configuration information, a write operation of writing the target information into the target ambient Internet of Things device includes:

sending second downlink control information to the target ambient Internet of Things device, where the second downlink control information includes at least one of the following: a write operation indication, the second identification information, the address information, and the first indication information; and

obtaining an operation result of executing the write operation by the target ambient Internet of Things device.

In some embodiments, a transmission module is further included, and is configured to send write operation execution information to the core network device, where the write operation execution information includes one of the following: successful completion of the write operation and a cause of not successfully executing the write operation or not executing the write operation.

In some embodiments, the cause of not successfully executing the write operation or not executing the write operation includes one of the following:

the target ambient Internet of Things device is not found; and

the target ambient Internet of Things device is found, but the write operation fails.

The ambient Internet of Things device read/write apparatus provided in this embodiment of this application can implement the processes implemented in the method embodiment of FIG. 2 and achieve a same technical effect. To avoid repetition, details are not described herein again.

FIG. 9 is a schematic diagram of a structure of an ambient Internet of Things device operation configuration apparatus according to an embodiment of this application. As shown in FIG. 9, the apparatus 900 mainly includes a receiving module 901 and a sending module 902.

In this embodiment of this application, the receiving module 901 is configured to receive an operation request from an application server, where the operation request is used to request to execute a target operation on a target ambient Internet of Things device, and the target operation includes one of the following: a read operation and a write operation. The sending module 902 is configured to send operation configuration information to a reader/writer based on the operation request, where the operation configuration information is used to indicate to execute the target operation on the target ambient Internet of Things device.

In some embodiments, the operation configuration information includes at least one of the following:

first identification information, where the first identification information is used to identify one of the following: the target ambient Internet of Things device and a target ambient Internet of Things device set, and the target ambient Internet of Things device set includes at least one target ambient Internet of Things device;

second identification information, where the second identification information is used to identify target information to be operated by the target operation;

address information, where the address information is used to indicate a storage address of the target information on the target ambient Internet of Things device;

first indication information, where the first indication information is used to indicate a size of the target information; and

second indication information, where the second indication information is used to indicate one of the following: to encrypt data transmitted between the target ambient Internet of Things device and the reader/writer and not to encrypt data transmitted between the target ambient Internet of Things device and the reader/writer.

In some embodiments, the operation configuration information includes read configuration information, and the read configuration information is used to indicate to execute a read operation on the target ambient Internet of Things device.

In some embodiments, the operation configuration information further includes at least one of the following:

third indication information, where the third indication information is used to indicate to execute one read operation on the target ambient Internet of Things device;

fourth indication information, where the fourth indication information is used to indicate to execute a periodic read operation on the target ambient Internet of Things device;

fifth indication information, where the fifth indication information is used to indicate to execute a semi-static read operation on the target ambient Internet of Things device; and

transmission/reception capability information of the target ambient Internet of Things device.

In some embodiments, the receiving module 901 is further configured to receive a read result sent by the reader/writer.

In some embodiments, the receiving module 901 is further configured to: in a case that the read result is that the read operation is not successfully executed or the read operation is not executed, receive read execution information sent by the reader/writer, where the read execution information is used to indicate a cause of not successfully executing the read operation or not executing the read operation.

In some embodiments, the cause of not successfully executing the read operation or not executing the read operation includes one of the following:

the target ambient Internet of Things device is not found;

the target ambient Internet of Things device is found, but reading the target information fails; and

the target ambient Internet of Things device is found, but the target information does not change after being read most recently.

In some embodiments, the operation configuration information includes write configuration information, and the write configuration information is used to indicate to execute a write operation on the target ambient Internet of Things device.

In some embodiments, the operation configuration information further includes: downlink reception capability information of the target ambient Internet of Things device.

In some embodiments, the receiving module 901 is further configured to:

receive write operation execution information sent by the reader/writer, where the write operation execution information includes one of the following: successful completion of the write operation and a cause of not successfully executing the write operation or not executing the write operation.

In some embodiments, the cause of not successfully executing the write operation or not executing the write operation includes one of the following:

the target ambient Internet of Things device is not found; and

the target ambient Internet of Things device is found, but the write operation fails.

The ambient Internet of Things device operation configuration apparatus provided in this embodiment of this application can implement the processes implemented in the method embodiment of FIG. 4 and achieve a same technical effect. To avoid repetition, details are not described herein again.

FIG. 10 is a schematic diagram of a structure of an ambient Internet of Things device read/write response apparatus according to an embodiment of this application. As shown in FIG. 10, the apparatus 1000 mainly includes a response module 1001 and a second execution module 1002.

In this embodiment of this application, the response module 1001 is configured to trigger the second execution module 1002 in response to a reader/writer executing a target operation on a target ambient Internet of Things device based on operation configuration information, where the operation configuration information is used to indicate to execute the target operation on the target ambient Internet of Things device, and the target operation includes one of the following: a read operation and a write operation. The second execution module 1002 is configured to execute the target operation.

In some embodiments, the second execution module 1002 is further configured to send identification information of the target ambient Internet of Things device to the reader/writer in response to a request from the reader/writer to read the identification information of the target ambient Internet of Things device.

In some embodiments, that the second execution module 1002 executes the target operation includes:

receiving first downlink control information sent by the reader/writer, where the first downlink control information includes at least one of the following: a read operation indication, second identification information identifying target information to be read by the read operation, storage address information of the target information on the target ambient Internet of Things device, and first indication information indicating a size of the target information;

obtaining the target information from internal storage space based on the first downlink control information; and

returning the obtained target information to the reader/writer.

In some embodiments, the response module 1001 is further configured to:

receive an inquiry request sent by the reader/writer, where the inquiry request is used to inquire at least one of the following: whether the target information is stored and whether the target information changes relative to content that is read most recently; and

send feedback information to the reader/writer, where the feedback information indicates that the target ambient Internet of Things device stores the target information and the target information changes relative to the content that is read most recently.

In some embodiments, that the second execution module 1002 executes the target operation includes:

receiving second downlink control information sent by the reader/writer, where the second downlink control information includes at least one of the following: a write operation indication, second identification information used to indicate target information to be written by the write operation, storage address information of the target information on the target ambient Internet of Things device, and first indication information indicating a size of the target information; and

receiving the target information from the reader/writer based on the second downlink control information, and storing the target information internally.

The ambient Internet of Things device read/write response apparatus provided in this embodiment of this application can implement the processes implemented in the method embodiment of FIG. 5 and achieve a same technical effect. To avoid repetition, details are not described herein again.

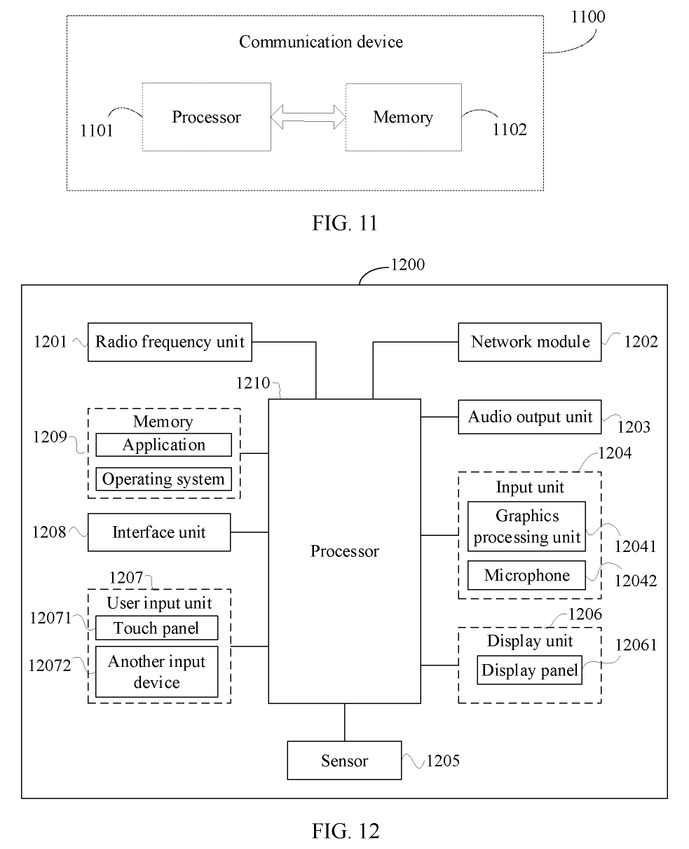

As shown in FIG. 11, an embodiment of this application further provides a communication device 1100, including a processor 1101 and a memory 1102. The memory 1102 stores a program or an instruction that is executable on the processor 1101. For example, in a case that the communication device 1100 is a reader/writer, the program or the instruction is executed by the processor 1101 to implement the steps of the embodiment of the ambient Internet of Things device read/write method, and a same technical effect can be achieved. In a case that the communication device 1100 is an ambient Internet of Things device, the program or the instruction is executed by the processor 1101 to implement the steps of the embodiment of the ambient Internet of Things device read/write response method, and a same technical effect can be achieved. In a case that the communication device 1100 is a network side device, the program or the instruction is executed by the processor 1101 to implement the steps of the embodiment of the ambient Internet of Things device operation configuration method, and a same technical effect can be achieved. To avoid repetition, details are not described herein again.

An embodiment of this application further provides a terminal, including a processor and a communication interface. The communication interface is coupled to the processor, and the processor is configured to run a program or an instruction to implement the steps in the method embodiment shown in FIG. 5. The terminal embodiment is corresponding to the method embodiment on the terminal side, each implementation process and implementation of the method embodiment can be applied to the terminal embodiment, and a same technical effect can be achieved. FIG. 12 is a schematic diagram of a hardware structure of a terminal according to an embodiment of this application.

The terminal 1200 includes but is not limited to at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art may understand that the terminal 1200 may further include a power supply (such as a battery) that supplies power to each component. The power supply may be logically connected to the processor 1210 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that, in this embodiment of this application, the input unit 1204 may include a graphics processing unit (GPU) 12041 and a microphone 12042, and the graphics processing unit 12041 processes image data of a still picture or a video obtained by an image capture apparatus (such as a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may include a volatile memory or a nonvolatile memory. The nonvolatile memory may be a read-only memory (ROM), a programmable read-only memory (PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1209 in this embodiment of this application includes but is not limited to these memories and any memory of another proper type.

The processor 1210 may include one or more processing units. In some embodiments, an application processor and a modem processor are integrated into the processor 1210. The application processor mainly processes an operating system, a user interface, an application, or the like. The modem processor mainly processes a wireless communication signal, for example, a baseband processor. It may be understood that, in some embodiments, the modem processor may not be integrated into the processor 1210.

The processor 1210 is configured to execute a target operation in response to a reader/writer executing the target operation on a target ambient Internet of Things device based on operation configuration information, where the operation configuration information is used to indicate to execute the target operation on the target ambient Internet of Things device, and the target operation includes one of the following: a read operation and a write operation.

It may be understood that for the implementation processes of the implementations mentioned in this embodiment, refer to the related descriptions of the method embodiment 5. A same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps in the method embodiment shown in FIGS. 2 or 4. This network side device embodiment is corresponding to the foregoing method embodiment of the network side device. Each implementation process and implementation of the foregoing method embodiment may be applicable to this network side device embodiment, and a same technical effect can be achieved.

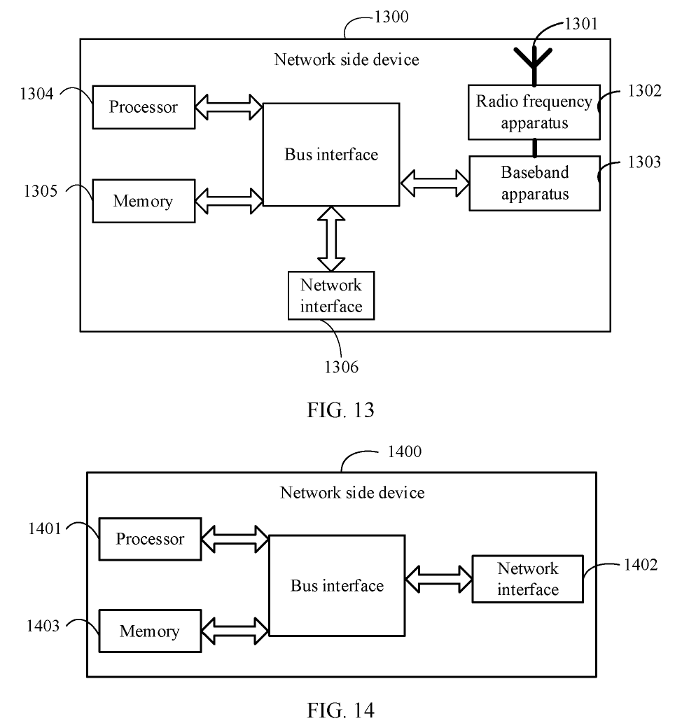

The present disclosure further provides a network side device. As shown in FIG. 13, the network side device 1300 includes an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information through the antenna 1301, and sends the received information to the baseband apparatus 1303 for processing. In a downlink direction, the baseband apparatus 1303 processes information that needs to be sent, and sends processed information to the radio frequency apparatus 1302. The radio frequency apparatus 1302 processes the received information, and sends processed information through the antenna 1301.

In the foregoing embodiment, the method performed by the network side device may be implemented in the baseband apparatus 1303. The baseband apparatus 1303 includes a baseband processor.

For example, the baseband apparatus 1303 may include at least one baseband board. A plurality of chips are disposed on the baseband board. As shown in FIG. 13, one chip is, for example, a baseband processor, and is connected to the memory 1305 through a bus interface, to invoke a program in the memory 1305 to execute the operations of the network device shown in the foregoing method embodiment.

The network side device may further include a network interface 1306, and the interface is, for example, a Common Public Radio Interface (CPRI).

In some embodiments, the network side device 1300 in this embodiment of this application further includes an instruction or a program that is stored in the memory 1305 and that is executable on the processor 1304. The processor 1304 invokes the instruction or the program in the memory 1305 to execute the method executed by the modules shown in FIG. 8, and a same technical effect is achieved. To avoid repetition, details are not described herein again.

The present disclosure further provides a network side device. As shown in FIG. 14, a network side device 1400 includes a processor 1401, a network interface 1402, and a memory 1403. The network interface 1402 is, for example, a common public radio interface (CPRI).

In some embodiments, the network side device 1400 in this embodiment of this application further includes an instruction or a program that is stored in the memory 1403 and that is executable on the processor 1401. The processor 1401 invokes the instruction or the program in the memory 1403 to execute the method executed by the modules shown in FIG. 9, and a same technical effect is achieved. To avoid repetition, details are not described herein again.

An embodiment of this application further provides a readable storage medium. The readable storage medium stores a program or an instruction. When the program or the instruction is executed by a processor, the processes of the embodiment of the ambient Internet of Things device read/write method are implemented, or the processes of the embodiment of the ambient Internet of Things device operation configuration method are implemented, or the processes of the embodiment of the ambient Internet of Things device read/write response method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or an instruction, to implement the processes of the embodiment of the ambient Internet of Things device read/write method, or implement the processes of the embodiment of the ambient Internet of Things device operation configuration method, or implement the processes of the embodiment of the ambient Internet of Things device read/write response method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the embodiment of the ambient Internet of Things device read/write method, or implement the processes of the embodiment of the ambient Internet of Things device operation configuration method, or implement the processes of the embodiment of the ambient Internet of Things device read/write response method, and a same technical effect can be achieved. To avoid repetition, details are not described herein again.

An embodiment of this application further provides an ambient Internet of Things device read/write system, including: a reader/writer, an ambient Internet of Things device, and a core network device. The reader/writer may be configured to perform the steps of the ambient Internet of Things device read/write method described above. The ambient Internet of Things device may be configured to perform the steps of the ambient Internet of Things device read/write response method described above. The core network device may be configured to perform the steps of the ambient Internet of Things device operation configuration method described above.

It should be noted that, in this specification, the term "include", "comprise", or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by "includes a..." does not preclude the existence of other identical elements in the process, method, article, or apparatus that includes the element. In addition, it should be noted that the scope of the method and apparatuses in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may understand that the method in the foregoing embodiment may be implemented by a computer software product in addition to a necessary universal hardware platform or by hardware only. The computer software product is stored in a storage medium (such as a ROM, a RAM, a magnetic disk, or an optical disc), and includes several instructions for instructing a terminal or a network side device to perform the methods in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make implementations in many forms without departing from the purpose of this application and the protection scope of the claims, the implementations fall within the protection of this application.

1. An ambient Internet of Things device read/write method, comprising:
obtaining, by a reader/writer, operation configuration information from a core network device, wherein the operation configuration information is used to indicate to execute a target operation on a target ambient Internet of Things device, and the target operation comprises one of the following: a read operation or a write operation; and
executing, by the reader/writer, the target operation on the target ambient Internet of Things device based on the operation configuration information.

2. The method according to claim 1, wherein the operation configuration information comprises at least one of the following:
first identification information, wherein the first identification information is used to identify one of the following: the target ambient Internet of Things device and a target ambient Internet of Things device set, and the target ambient Internet of Things device set comprises at least one target ambient Internet of Things device;
second identification information, wherein the second identification information is used to identify target information to be operated by the target operation;
address information, wherein the address information is used to indicate a storage address of the target information on the target ambient Internet of Things device;
first indication information, wherein the first indication information is used to indicate a size of the target information; or
second indication information, wherein the second indication information is used to indicate one of the following: to encrypt data transmitted between the target ambient Internet of Things device and the reader/writer and not to encrypt data transmitted between the target ambient Internet of Things device and the reader/writer.

3. The method according to claim 2, wherein before the executing, by the reader/writer, the target operation on the target ambient Internet of Things device based on the operation configuration information, the method further comprises:
reading, by the reader/writer, third identification information of a candidate ambient Internet of Things device from the candidate ambient Internet of Things device; and
when the read third identification information matches the first identification information, determining, by the reader/writer, the candidate ambient Internet of Things device as the target ambient Internet of Things device.

4. The method according to claim 2, wherein:
the operation configuration information comprises read configuration information, and the read configuration information is used to indicate to execute a read operation on the target ambient Internet of Things device; and
the executing, by the reader/writer, the target operation on the target ambient Internet of Things device based on the operation configuration information comprises: executing, by the reader/writer based on the operation configuration information, a read operation of reading the target information from the target ambient Internet of Things device.

5. The method according to claim 4, wherein the operation configuration information further comprises at least one of the following:
third indication information, wherein the third indication information is used to indicate to execute one read operation on the target ambient Internet of Things device;
fourth indication information, wherein the fourth indication information is used to indicate to execute a periodic read operation on the target ambient Internet of Things device;
fifth indication information, wherein the fifth indication information is used to indicate to execute a semi-static read operation on the target ambient Internet of Things device; or
transmission/reception capability information of the target ambient Internet of Things device.

6. The method according to claim 5, wherein:
the fourth indication information and the fifth indication information each comprise: time-related information of first-time read and read periodicity information, and
the time-related information of the first-time read comprises one of the following: time offset information of the first-time read or read time of the first-time read.

7. The method according to claim 6, wherein the fifth indication information further comprises at least one of the following:
an indication to activate or reactivate the semi-static read operation;
an indication to stop or pause the semi-static read operation;
an indication of a time period for executing the semi-static read operation; or
a quantity of read times for executing the semi-static read operation.

8. The method according to claim 4, wherein the executing, by the reader/writer based on the operation configuration information, a read operation of reading the target information from the target ambient Internet of Things device comprises:
sending, by the reader/writer, first downlink control information to the target ambient Internet of Things device, wherein the first downlink control information comprises at least one of the following: a read operation indication, the second identification information, the address information, and the first indication information; and
receiving, by the reader/writer, a read result returned by the target ambient Internet of Things device.

9. The method according to claim 8, wherein before the sending, by the reader/writer, first downlink control information to the target ambient Internet of Things device, the method further comprises:
sending, by the reader/writer, an inquiry request to the target ambient Internet of Things device, wherein the inquiry request is used to inquire at least one of the following: whether the target information is stored and whether the target information changes relative to content that is read most recently; and
receiving, by the reader/writer, feedback information returned by the target ambient Internet of Things device.

10. The method according to claim 9, wherein the sending, by the reader/writer, first downlink control information to the target ambient Internet of Things device comprises:
sending, by the reader/writer, the first downlink control information to the target ambient Internet of Things device when the feedback information indicates that the target information is stored and the target information changes relative to the content that is read most recently.

11. The method according to claim 9, further comprising:
terminating, by the reader/writer, a read procedure of the target information when the feedback information indicates that the target information is not stored or the target information does not change relative to the content that is read most recently.

12. The method according to claim 4, wherein after the executing, by the reader/writer based on the operation configuration information, a read operation of reading the target information from the target ambient Internet of Things device, the method further comprises:
sending, by the reader/writer, a read result of executing the read operation to the core network device.

13. The method according to claim 12, further comprising:
when the read result is that the read operation is not successfully executed or the read operation is not executed, sending, by the reader/writer, read execution information to the core network device,
wherein the read execution information is used to indicate a cause of not successfully executing the read operation or not executing the read operation.

14. The method according to claim 13, wherein the cause of not successfully executing the read operation or not executing the read operation comprises one of the following:
the target ambient Internet of Things device is not found;
the target ambient Internet of Things device is found, but reading the target information fails; or
the target ambient Internet of Things device is found, but the target information does not change after being read most recently.

15. An ambient Internet of Things device operation configuration method, comprising:
receiving, by a core network device, an operation request from an application server, wherein the operation request is used to request to execute a target operation on a target ambient Internet of Things device, and the target operation comprises one of the following: a read operation or a write operation; and
sending, by the core network device, operation configuration information to a reader/writer based on the operation request, wherein the operation configuration information is used to indicate to execute the target operation on the target ambient Internet of Things device.

16. The method according to claim 15, wherein the operation configuration information comprises at least one of the following:
first identification information, wherein the first identification information is used to identify one of the following: the target ambient Internet of Things device and a target ambient Internet of Things device set, and the target ambient Internet of Things device set comprises at least one target ambient Internet of Things device;
second identification information, wherein the second identification information is used to identify target information to be operated by the target operation;
address information, wherein the address information is used to indicate a storage address of the target information on the target ambient Internet of Things device;
first indication information, wherein the first indication information is used to indicate a size of the target information; or
second indication information, wherein the second indication information is used to indicate one of the following: to encrypt data transmitted between the target ambient Internet of Things device and the reader/writer and not to encrypt data transmitted between the target ambient Internet of Things device and the reader/writer.

17. The method according to claim 16, wherein the operation configuration information comprises read configuration information, and the read configuration information is used to indicate to execute a read operation on the target ambient Internet of Things device.

18. The method according to claim 17, wherein the operation configuration information further comprises at least one of the following:
third indication information, wherein the third indication information is used to indicate to execute one read operation on the target ambient Internet of Things device;
fourth indication information, wherein the fourth indication information is used to indicate to execute a periodic read operation on the target ambient Internet of Things device;
fifth indication information, wherein the fifth indication information is used to indicate to execute a semi-static read operation on the target ambient Internet of Things device; or
transmission/reception capability information of the target ambient Internet of Things device.

19. The method according to claim 16, wherein the operation configuration information comprises write configuration information, and the write configuration information is used to indicate to execute a write operation on the target ambient Internet of Things device.

20. A reader/writer, comprising a processor and a memory, wherein the memory stores an instruction that, when executed by the processor, causes the processor to perform operations comprising:
obtaining, by a reader/writer, operation configuration information from a core network device, wherein the operation configuration information is used to indicate to execute a target operation on a target ambient Internet of Things device, and the target operation comprises one of the following: a read operation or a write operation; and
executing, by the reader/writer, the target operation on the target ambient Internet of Things device based on the operation configuration information.
